(19) United States
(12) Patent Application Publication
(10) Pub. No.: US 2004/0049525 A1
(43) Pub. Date: Mar. 11, 2004

(54) Feedback random number generation method and system

(75) Inventor: Laszlo Hars, Cortlandt Manor, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V.

(21) Appl. No.: 10/236,178

(22) Filed: Sep. 6, 2002

(51) Int. Cl. G06F 1/02

(52) U.S. Cl. 708/250

(57) ABSTRACT

A physical random number generator operates to generate a true random bit sequence while a linear feedback shift register and a clock collectively operate to provide a plurality of feedback random bit sequences. In operation, the linear feedback shift register periodically latches the feedback random bit sequences in response to a clock signal having a predetermined operating frequency from the clock. In latching the feedback random bit sequences, the linear feedback shift register includes a plurality of bi-stable latches for linearly shifting a mixed random bit sequence outputted by an XOR gate, which is combined with the true random bit sequence. A decimator receives a feedback random bit sequence and provides an output random bit sequence that is representative of a selective outputting of the feedback random bit sequence.

### TECHNICAL FIELD

The present invention generally relates to physical random number generators (i.e., a device that generates a bit or bits representative of a number by operating one or more components of the device in an undeterminable manner). The present invention specifically relates to an improvement of a randomness of a physical random number generator.

### BACKGROUND AND SUMMARY OF THE INVENTION

Physical random number generators as known in the art generate a random number bit or bits by operating one or more components of the device in an undeterminable manner. Conceptually, the undeterminable operation of the component(s) yields an unbiased random generation of the random number bit(s). In practice, the undeterminable operation of the component(s) typically yields a biased generation of the random number bit(s) due to various tolerances related to the operation of the component(s).

The present invention employs a linear feedback shift register and a decimator to improve upon a biased generation of a true random bit sequence by a physical random number generator. Various aspects of the present invention are novel, non-obvious, and provide various advantages. While the actual nature of the present invention covered herein can only be determined with reference to the claims appended hereto, certain features, which are characteristic of the embodiments disclosed herein, are described briefly as follows.

One form of the present invention is a random number generation system comprising a physical random number generator, a linear feedback shift register,

One form of the present invention is a random number generation system comprising a physical random number generator, a linear feedback shift register, a clock, and a decimator. The physical random number generator operates to generate one or more true random bit sequences that are communicated to the linear feedback shift register, which operates to periodically latch one or more feedback random bit sequences as a function of the true random bit sequence(s). A clock signal from the clock triggers the periodic latching of the feedback random bit sequence(s) by the linear feedback shift register. The periodic latching of one of feedback random bit sequences is communicated to the decimator, which operates to provide one or more output random bit sequences that are representative of a selective outputting of the feedback random bit sequence(s).

The foregoing form as well as other forms, features and advantages of the present invention will become further apparent from the following detailed description of the presently preferred embodiments, read in conjunction with the accompanying drawings. The detailed description and drawings are merely illustrative of the present invention rather than limiting, the scope of the present invention being defined by the appended claims and equivalents thereof.

### BRIEF DESCRIPTION OF THE DRAWINGS

FIG. 1 illustrates a block diagram of a first embodiment of a random number generation system in accordance with the present invention;

FIG. 2 illustrates a schematic diagram of a first embodiment of the FIG. 1 random number generation system in accordance with the present invention; and

FIG. 3 illustrates a block diagram of a second embodiment of the FIG. 1 random number generation system in accordance with the present invention.

### DETAILED DESCRIPTION OF THE INVENTION

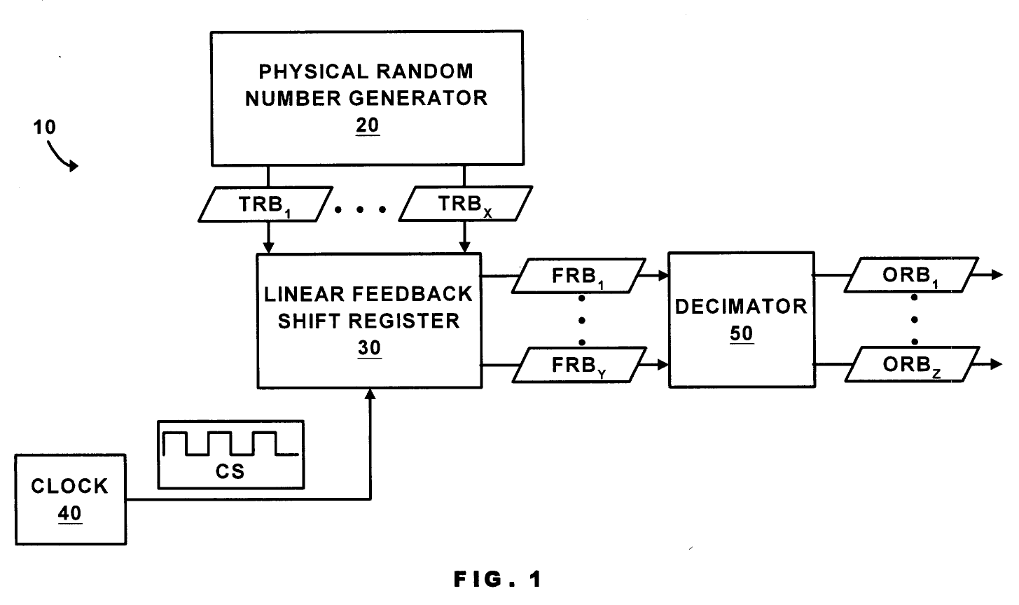

FIG. 1 illustrates a random number generation system 10 (hereinafter “system 10”) comprising a physical random number generator 20 (hereinafter “PRNG 20”), linear feedback shift register 30 (hereinafter “LFSR 30”), a conventional clock 40, and a conventional decimator 50. The PRNG 20 is in communication with the LFSR 30 to thereby provide one or more true random bit sequences TRB₁-TRB_{X} to the logic LFSR 30. The LFSR 30 operates to periodically latch one or more feedback random bit sequences FRB₁-FRB_{Y} as a function of the true random bit sequences TRB₁-TRB_{X}. The clock 40 is in communication with the LFSR 30 to thereby provide a clock signal CS to the LFSR 30, the clock signal CS having a predetermined operating frequency for triggering a periodic latching of the feedback random bit sequences FRB₁-FRB_{Y} by the LFSR 30. The LSFR 30 is in communication with the decimator 50 to thereby provide the feedback random bit sequences FRB₁-FRB_{Y} to the decimator 50 whereby the decimator 50 provides an one or more output random bit sequence ORB₁-ORB_{Z} that are representative of a selective outputting of the feedback random bit sequences FRB₁-FRB_{Y}.

The number of configurations of the PRNG 20, the LFSR 30, the clock 40, and the decimator 50 is without limit. Additionally, the aforementioned communications among the PRNG 20, the LFSR 30, the clock 40, and the decimator 50 can be achieved in numerous ways (e.g., electrically, optically, acoustically, and/or magnetically). The number of embodiments of the system 10 is therefore essentially limitless.

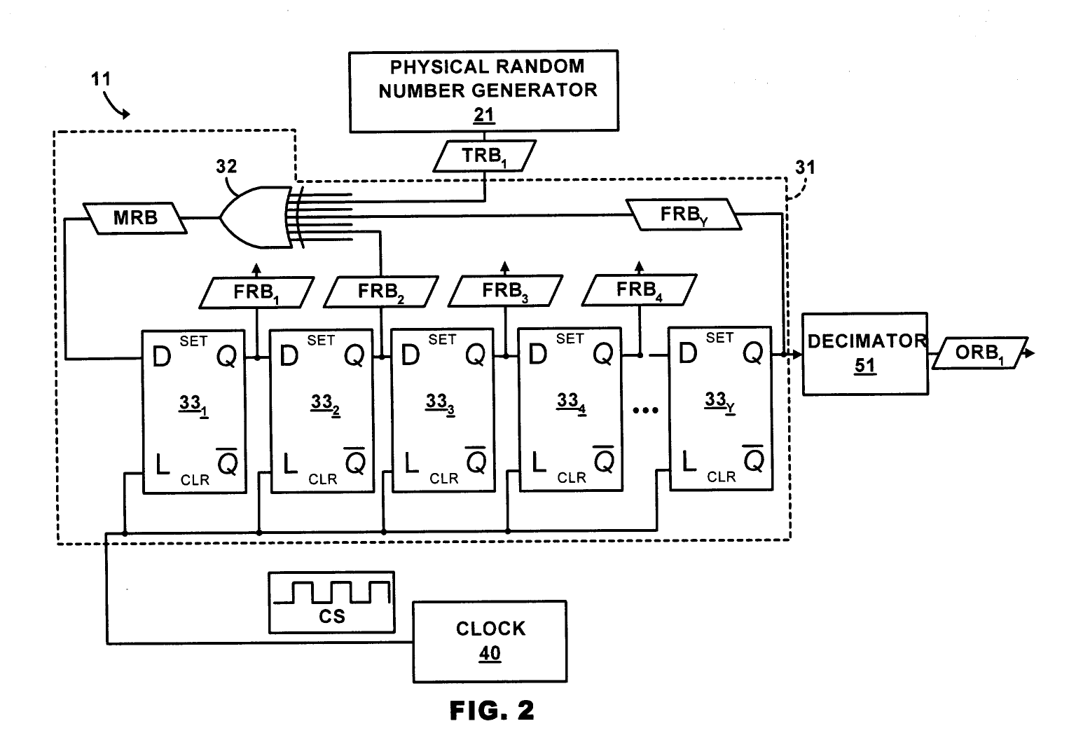

FIG. 2 illustrates a random number generation system 11 (hereinafter “system 11”) as one embodiment of system 10 (FIG. 1). The system 11 includes a physical random number generator 21 (hereinafter “PRNG 21”) and a linear feedback shift register 31 (hereinafter “LFSR 31”). The PRNG 21 is operable to a true random bit sequence TRB, (X=1). In one embodiment, the PRNG 21 is configured in accordance with a U.S. Patent Application Serial No. [FILL IN} entitled “Latching Electronic Circuit For Random Number Generation”, the entirety of which is hereby incorporated by reference and commonly owned by the assignee. In another embodiment, the PRNG 21 is configured in accordance with a U.S. Patent Application Serial No. [FILL IN} entitled “Switching Electronic Circuit For Random Number Generation”, the entirety of which is hereby incorporated by reference and commonly owned by the assignee.

The LFSR 31 includes a logic circuit in the form of an XOR gate 32 having a first input electrically coupled to the PRNG 21 to thereby receive the true random bit sequence TRB₁. The LFSR 31 further includes a conventional arrangement of bi-stable latches in the form of D-type flip-flops 33₁-33_{Y} where a data output Q is electrically coupled to a data input D of a succeeding flip flop. Each flip-flop 33₁-33_{Y} periodically latches a corresponding feedback random bit sequence FRB₁-FRB_{Y} in response to a reception of the clock signal CS. The clock 40 is electrically coupled to each latch input 1 of the flip-flops 33₁-33_{Y} to thereby provide the clock signal CS to each flip-flop 33₁-33_{Y}. To enforce a periodic latching of the feedback random bit sequences FRB₁-FRB_{Y} by the flip-flops 33₁-33_{Y}, a triggering transition time of the clock signal CS honors the data setup and hold times of the flip-flops 33₁-33_{Y}.

The data output Q of a flip-flop 332 is electrically coupled to a second input of the XOR gate 32 to thereby provide a feedback random bit sequence FRB₂ to the XOR gate 32. The data output Q of a flip-flop 33_{Z} is electrically coupled to a second input of the XOR gate 32 to thereby provide a feedback random bit sequence FRB_{Y} to the XOR gate 32. The data output Q of a number of the other flip-flops can be currently electrically coupled to the other illustrated inputs of the XOR gate 32 to thereby provide additional feedback random bit sequences to the XOR gate 32. The output of the XOR gate 32 is electrically coupled to the data input D of the first flip-flop 33₁ to thereby provide a mixed random bit sequence MRB to the flip-flop 33₁. The Q output of the flip-flop 32_{Y} is also electrically coupled to a decimator 51 to thereby provide the feedback random bit sequence FRB_{Y} to the decimator 51 whereby the decimator 51 provides an output random bit sequence ORB₁ (Z=1) that is representative of a selective outputting of the feedback random bit sequence FRB_{Y}. In one embodiment, the decimator 51 is a counter having a data input electrically coupled to the Q output of the flip-flop 32_{Y} whereby a selection input of the counter is controlled to implement a selective outputting of the feedback random bit sequence FRB_{Y}.

System 11 can be varied in numerous ways to yield alternative embodiments of system 11 as would be appreciated by those having ordinary skill in the art. For example, to enhance and/or alter the bit mixing, different feedback random bit sequences among FRB₁-FRB_{Y} can be communicated to XOR gate 32. Second, only one feedback random bit sequence among feedback random bit sequences FRB₁-FRB_{Y} can be communicated to embodiments of a logic circuit having two inputs. Third, additional true random bit sequences among TRB₂-TRB_{X} (FIG. 1) and/or additional feedback random bit sequences among feedback random bit sequences FRB₁-FRB_{Y} can be communicated to embodiments of a logic circuit having four or more inputs. Fourth, additional mixed random bit sequences can be communicated to LFSR 31 and/or additional LFSRs 31. Fifth, one or more of the inverted data outputs Q of the flip-flops 33₁-33_{Y} can be utilized to generate the one or more of the feedback random bit sequences FRB₁-FRB_{Y}. Sixth, other types of bi-stable latches can be substituted for one or more of the D-type flip-flops 33₁-33_{Y}.

An operation of the system 11 will now be described herein. For purposes of the operational description, an initial state of the system 11 consists of the true random bit sequence TRB₁ and the feedback random bit sequences FRB₁-FRB_{Y} being set as 0 bits. Accordingly, the mixed bit MRB is also set as a 0 bit. Also for purposes of the operational description, the LFSR 31 consists of five (5) flip-flops 33₁-33₅ where the illustrated flip-flop 33_{Y} serves as the flip-flop 33₅. Further, the flip-flops 33₁-33₅ are designed to be triggered upon a rising edge of the clocks signal CS.

The following TABLE 1 illustrates an exemplary operation of the system 11 when the PRNG 20 is biased toward generating the true random bit sequence TRB₁ as a 1 bit:

TABLE 1

| TIME | TRB₁ | MRB | FRB₁ | FRB₂ | FRB₃ | FRB₄ | FRB₅ |
|---|---|---|---|---|---|---|---|
| T₀ | 1 | 1 | 0 | 0 | 0 | 0 | 0 |
| T₁ | 1 | 1 | 1 | 0 | 0 | 0 | 0 |
| T₂ | 1 | 1 | 1 | 1 | 0 | 0 | 0 |
| T₃ | 1 | 1 | 1 | 1 | 1 | 0 | 0 |
| T₄ | 1 | 1 | 1 | 1 | 1 | 1 | 0 |
| T₅ | 1 | 1 | 1 | 1 | 1 | 1 | 1 |
| T₆ | 1 | 0 | 0 | 1 | 1 | 1 | 1 |
| T₇ | 1 | 0 | 0 | 0 | 1 | 1 | 1 |
| T₈ | 1 | 1 | 1 | 0 | 0 | 1 | 1 |
| T₉ | 1 | 1 | 1 | 1 | 0 | 0 | 1 |
| T₁₀ | 1 | 0 | 0 | 1 | 1 | 0 | 0 |
| T₁₁ | 1 | 1 | 0 | 0 | 1 | 1 | 0 |
| T₁₂ | 1 | 1 | 1 | 0 | 0 | 1 | 1 |
| T₁₃ | 1 | 1 | 1 | 1 | 0 | 0 | 1 |
| T₁₄ | 1 | 0 | 0 | 1 | 1 | 0 | 0 |
| T₁₅ | 1 | 1 | 1 | 0 | 1 | 1 | 0 |
| T₁₆ | 1 | 1 | 1 | 1 | 0 | 1 | 1 |
| T₁₇ | 1 | 0 | 0 | 1 | 1 | 1 | 0 |
| T₁₈ | 1 | 1 | 1 | 0 | 1 | 1 | 1 |
| T₁₉ | 1 | 1 | 1 | 1 | 0 | 1 | 1 |
| T₂₀ | 1 | 0 | 1 | 1 | 1 | 0 | 1 |

The following TABLE 2 illustrates another exemplary operation of the system 11 when the PRNG 20 is not very random generating the true random bit sequence TRB, as a periodic 0011 sequence:

TABLE 2

| TIME | TRB₁ | MRB | FRB₁ | FRB₂ | FRB₃ | FRB₄ | FRB₅ |
|---|---|---|---|---|---|---|---|
| T₀ | 0 | 0 | 0 | 0 | 0 | 0 | 0 |
| T₁ | 0 | 0 | 0 | 0 | 0 | 0 | 0 |
| T₂ | 0 | 0 | 0 | 0 | 0 | 0 | 0 |
| T₃ | 1 | 1 | 0 | 0 | 0 | 0 | 0 |
| T₄ | 1 | 1 | 1 | 0 | 0 | 0 | 0 |
| T₅ | 0 | 0 | 0 | 1 | 1 | 0 | 0 |
| T₆ | 0 | 0 | 0 | 0 | 1 | 1 | 0 |
| T₇ | 1 | 1 | 1 | 0 | 0 | 1 | 1 |
| T₈ | 1 | 1 | 1 | 1 | 0 | 0 | 1 |
| T₉ | 0 | 1 | 1 | 1 | 1 | 0 | 0 |
| T₁₀ | 0 | 1 | 1 | 1 | 1 | 1 | 0 |
| T₁₁ | 1 | 1 | 1 | 1 | 1 | 1 | 1 |
| T₁₂ | 1 | 0 | 0 | 1 | 1 | 1 | 1 |
| T₁₃ | 0 | 1 | 1 | 0 | 1 | 1 | 1 |
| T₁₄ | 0 | 1 | 1 | 1 | 0 | 1 | 1 |
| T₁₅ | 1 | 0 | 0 | 1 | 1 | 0 | 1 |
| T₁₆ | 1 | 0 | 0 | 0 | 1 | 1 | 0 |
| T₁₇ | 0 | 0 | 0 | 0 | 0 | 1 | 1 |
| T₁₈ | 0 | 1 | 1 | 0 | 0 | 0 | 1 |
| T₁₉ | 1 | 1 | 1 | 1 | 0 | 0 | 0 |
| T₂₀ | 1 | 1 | 1 | 1 | 1 | 0 | 0 |

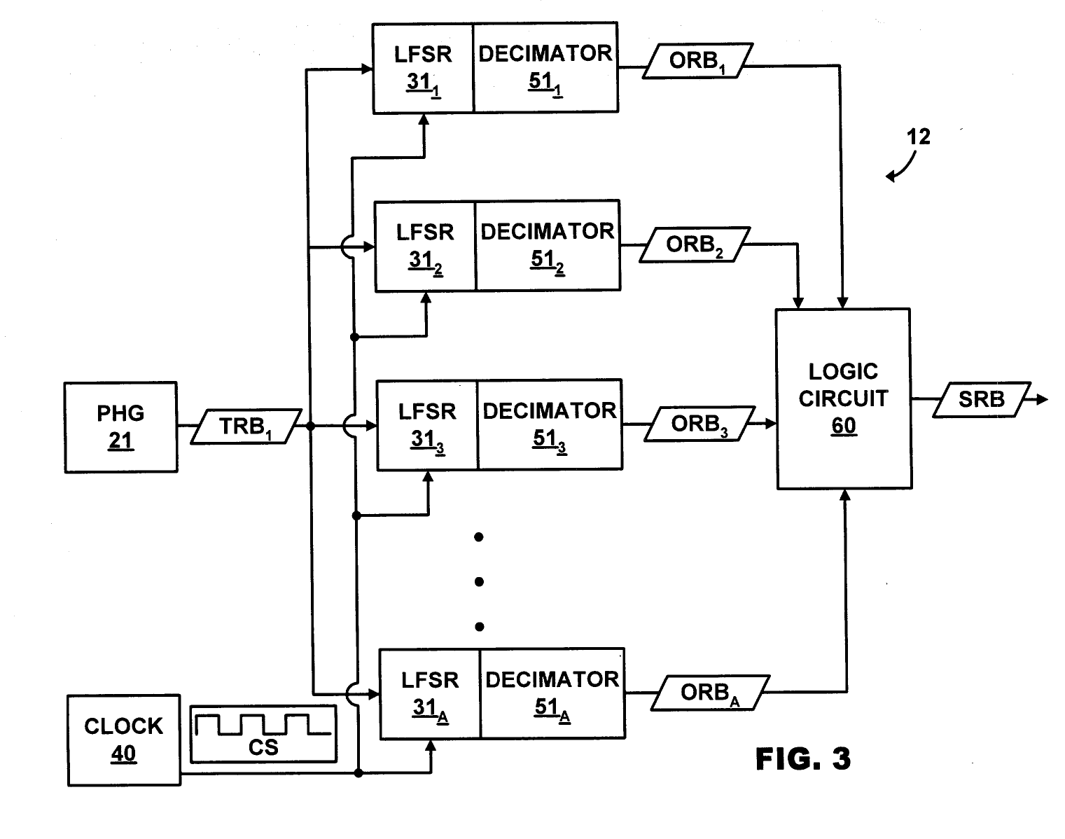

FIG. 3 illustrates a random number generation system 12 (hereinafter “system 12”) as another embodiment of system 10 (FIG. 1). The system 12 employs the PRNG 21, the clock 40, a plurality of LFSRs 31₁-31_{A}, a plurality of decimators 51₁-51_{A}, and a logic circuit 60 (e.g., a multi-input XOR gate). The decimators 51₁-51_{A} are in communication with logic circuit 60 to thereby provide a plurality of output random bit sequences ORB₁-ORB_{A} to the logic circuit 60. In response thereto, the logic circuit 60 will provide a system random bit sequence SRB that is sufficiently insensitive to any of the output random bit sequences ORB₁-ORB_{A} being provided as a constant bit stream. As long as any one of the corresponding pairs of LFSRs 31₁-31_{A} and decimators 51₁-51_{A} produce random bits, the resulting system random bit sequence SRB will also be random. On a VLSI chip, integrating several hundreds of different LFSRs 31₁-31_{A} and decimators 51₁-51_{A} is feasible and the resulting bit stream will be highly unpredictable.

System 12 can be varied in numerous ways to yield alternative embodiments of system 12 as would be appreciated by those having ordinary skill in the art. For example, alternative to each LFSR 31₁-31_{A} receiving the clock signal CS, additional clocks can be employed within an alternative embodiment of system 12 to provide two or more clock signals of different frequencies with each clock signal being strategically provided to selected LFSRs 31₁-31_{A}. Second, additional PRNGs 21 can be employed within an alternative embodiment of system 12 with each true random bit sequence being strategically provided to the selected LFSRs 31₁-31_{A}. Third, one or more of the decimators 51₁-51_{A} can be in communication with two or more of the LFSRs 31₁-31_{A}. Fourth, the decimators 51₁-51_{A} can be removed and the LFSRs 31₁-31_{A} can be in communication with the logic circuit 60 whereby the system random bit sequence SRB is a function of selected feedback random bit sequences from the LFSRs 31₁-31_{A}.

While the embodiments of the present invention disclosed herein are presently considered to be preferred, various changes and modifications can be made without departing from the spirit and scope of the present invention. The scope of the present invention is indicated in the appended claims, and all changes that come within the meaning and range of equivalents are intended to be embraced therein.

What is claimed is:

1. A random number generator system, comprising:
a physical random number generator operable to generate one or more true random bit sequences;
a linear feedback shift register operable to periodically latch one or more feedback random bit sequences as a function of the one or more true random bit sequences; and
a clock operable to provide a clock signal having a predetermined operating frequency for triggering a periodic latching of the one or more feedback random bit sequences by said linear feedback shift register.

2. The random number generation system, further comprising:
a decimator operable to provide one or more output random bit sequences that are representative of a selective outputting of the one or more feedback random bit sequences.

3. A random number generator system, comprising:
a physical random number generator operable to generate a true random bit sequence;
a linear feedback shift register operable to periodically latch one or more feedback random bit sequences as a function of the true random bit sequence; and
a clock operable to provide a clock signal having a predetermined operating frequency for triggering a periodic latching of the one or more feedback random bit sequences (FRB₁-FRB_{Z}) by said linear feedback shift register.

4. The random number generator system of claim 3, comprising:
a decimator operable to provide an output random bit sequences that is representative of a selective outputting of a first feedback random bit sequence of the one or more feedback random bit sequences.

5. The random number generation system of claim 3, wherein said linear feedback shift register includes
a logic circuit operable to generate one or more mixed random bit sequences in response to a reception of the true random bit sequence and a reception of a first feedback random bit sequence of the one or more feedback random bit sequences, and
at least one bi-stable latch operable to generate the one or more feedback random bit sequences in response to a reception of the one or more mixed random bit sequences and the clock signal.

6. A random number generator system, comprising:
a physical random number generator operable to provide one or more true random bit sequences;
a plurality of linear feedback shift registers operable to receive the one or more true random bit sequences, wherein a first linear feedback shift register is operable to periodically latch one or more feedback random bit sequences as a function of the one or more true random bit sequences; and
a clock operable to provide a clock signal having a predetermined operating frequency for triggering a periodic latching of the one or more feedback random bit sequences by said first linear feedback shift register.

7. The random number generation system of claim 6, further comprising:
a plurality of decimators operable to output one or more output random bit sequences that are representative of a selective outputting of the feedback random bit sequences.

8. The random number generation system of claim 7, further comprising:
a logic circuit operable to provide a system random bit sequence as a function of the one or more output random bit sequences.

9. The random number generation system of claim 6, further comprising:
a logic circuit operable to provide a system random bit sequence as a function of the feedback random bit sequences.

10. The random number generation system of claim 6, wherein said first linear feedback shift register includes
a logic circuit operable to generate one or more mixed random bit sequences in response to a reception of a first true random bit sequence and a reception of a first feedback random bit sequence of the one or more feedback random bit sequences; and
at least one bi-stable latch operable to generate the one or more feedback random bit sequences in response to a reception of the one or more mixed random bit sequences and the clock signal.
